(19) United States
(12) Patent Application Publication
(10) Pub. No.: US 2010/0008114 A1
(43) Pub. Date: Jan. 14, 2010

(54) DISCONTINUOUS PROTECTION METHOD FOR CLAMPING CURRENT IN INVERTER

(76) Inventors: Hsien-Chung LEE, Taoyuan Shien (TW); Cheng-Te Chen, Taoyuan Shien (TW)

Correspondence Address: HDLS Patent & Trademark Services, P.O. BOX 220746, CHANTILLY, VA, 20153-0746, US

(21) Appl. No.: 12/172,370

(22) Filed: Jul. 14, 2008

(51) Int. Cl. H02M 5/42

(52) U.S. Cl. 363/98

(57) ABSTRACT

A discontinuous protection method clamps phase currents in an inverter initially sets a current clamping flag and a current threshold. The phase currents are alternatively cut out by a criterion based on the current-clamp flag and based on whether the phase currents exceed the current threshold. By proving current in discontinuous way under certain situation judged by the criterion, over current protection and shut-down of inverter can be prevented. The method further sets a carrier frequency modulation flag. The carrier frequency is increased to 8 KHz when the phase current is to be cut out, thus speeding up protection for clamping current.

### BACKGROUND OF THE INVENTION

1. Field of the Invention

The present invention relates to a method for protecting inverter, especially to a discontinuous protection method clamping phase currents in an inverter.

2. Description of Prior Art

Inverter is used to convert wall socket power (50-60 Hz) to AC power of desirable frequency and voltage, and is extensively used for motor control application. FIG. 1 shows a conventional motor control system using inverter. The motor control system receives an AC power 30 for driving a motor 20, and comprises an AC-to-DC converter 12, a PWM generator 14, a gate driver 16 and an inverter 18. The motor control system further comprises a CPU 40 for controlling all other components in the motor control system. The AC-to-DC converter 12 generates a low-voltage DC power to the PWM generator 14, and generates a high-voltage DC power to the inverter 18. The PWM generator 14 is controlled by the CPU 40 to generate PWM signals of different frequencies and duty ratios. The gate driver 16 receives the PWM signals to drive the inverter 18. Therefore, the motor 20 can be driven in variable-frequency way.

FIG. 2 shows the six-bridge IFBT switches in the inverter 18. The six-bridge IFBT switches comprise IGBT switches 50 at three upper arms and three lower arms, respectively, and corresponding diodes (no label). The gates of the IGBT switches 50 are selectively turned on by the control of the gate driver 16 to supply the high-voltage DC power to the motor 20. Moreover, a low-side shunt resistor 52 is provided for each of the lower-arm IGBT switches 50 to sense the three phase current, thus enabling feedback control of the motor control system.

FIG. 3 shows the way of the PWM signals generated by the PWM generator 14, where the PWM generator 14 compares a triangular carrier signal with a sinusoid signal. The pulse in the PWM signals is positive (namely, on state) when the triangular carrier signal is larger than the sinusoid signal. The use of the low-side shunt resistor for current detection has the advantage of low cost and compact size. However, in over modulation case, namely, the maximal value of the sinusoid signal is larger than the maximal value of the carrier signal, one phase current (such as U phase current) flowing through the IGBT switch 50 is continuously turned on. In this situation, load current (motor current) will not flow through the low-side shunt resistor 52 for U phase current. FIG. 4 shows the currents in IGBT switch 50, where the two top curves are corresponding to U phase current in two IGBT switches 50 (upper and lower arms), the third curve is corresponding to current flowing through the low-side shunt resistor 52 for U phase current, and the bottom curve is U phase output current. As can be seen from this figure, two IGBT switches 50 with waveforms manifested by two top curves have dense waveforms corresponding to the continuously turned-on state.

However, the continuously turned-on state will deteriorate the current clamp (CC) property and the output current cannot be clamped to predetermined level. As a result, over current (OC) protection is probably triggered. Therefore, the inverter will abnormally stop and the lifetime of the IGBT module is shortened. FIG. 5 shows the three phase current waveforms corresponding to the continuously turned-on state of IGBT switches 50. Over current (OC) protection is probably triggered and the inverter abnormally stop. The continuously turned-on state of IGBT switches 50 also happens for Discontinuous PWM (DPWM) scheme beside over modulation operation.

### SUMMARY OF THE INVENTION

It is the object of the present invention to provide a discontinuous protection method clamping phase currents in an inverter.

Accordingly, the method of the present invention initially sets a current clamping flag and a current threshold. The phase currents are alternatively cut out by a criterion based on the current-clamp flag and based on whether the phase currents exceed the current threshold. By proving current in discontinuous way under certain situation judged by the criterion, over current protection and shut-down of inverter can be prevented. The method further sets a carrier frequency modulation flag. The carrier frequency is increased to 8 KHz when the phase current is to be cut out, thus speeding up protection for clamping current.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows a conventional motor control system using inverter.

FIG. 2 shows the six-bridge IFBT switches in the inverter.

FIG. 3 shows the way of the PWM signals generated by the PWM generator.

FIG. 4 shows the currents in IGBT switch.

FIG. 5 shows the three phase current waveforms corresponding to the continuously turned-on state of IGBT switches.

FIG. 6 shows the flowchart of discontinuous protection method clamps phase currents in an inverter.

FIG. 7 shows the detailed sub-steps in the phase current cutting step.

FIG. 8 shows detailed sub-steps for implementing the step for enabling the carrier frequency modulation flag and the step for disabling the carrier frequency modulation flag.

FIG. 9 shows the three phase current of IGBT switches when the IGBT switched are continuously turned on.

### DETAILED DESCRIPTION OF THE INVENTION

FIG. 6 shows the flowchart of discontinuous protection method clamps phase currents in an inverter. The method of the present invention can be implemented as a subroutine called by a mail program of motor controller. After the subroutine is finished the procedure returns to the main program. After the system employing the inverter starts, the protection method checks whether the inverter has output (S100). If the inverter has output, the digital values of three phase currents are measured (S102). Step S110 judges whether the output frequency in the digital values exceeds a frequency threshold, if true, then step S112 is performed. Step S112 judges whether the digital values exceeds a current threshold and a current clamping flag is logical zero. If both conditions are matched, step S130 is performed to cut out phase current. If one of the conditions (the digital values exceeds a current threshold and a current clamping flag is logical zero) is not satisfied, step S122 is performed to output phase current and set the current clamping flag to logical zero. After S130 and S122, step S132 is performed to increase a current clamping count CC_CNT by one. Step S140 checks whether the current clamping count exceeds a count limit, if true, a carrier frequency modulation flag is disabled (S142), else the procedure return to the main program.

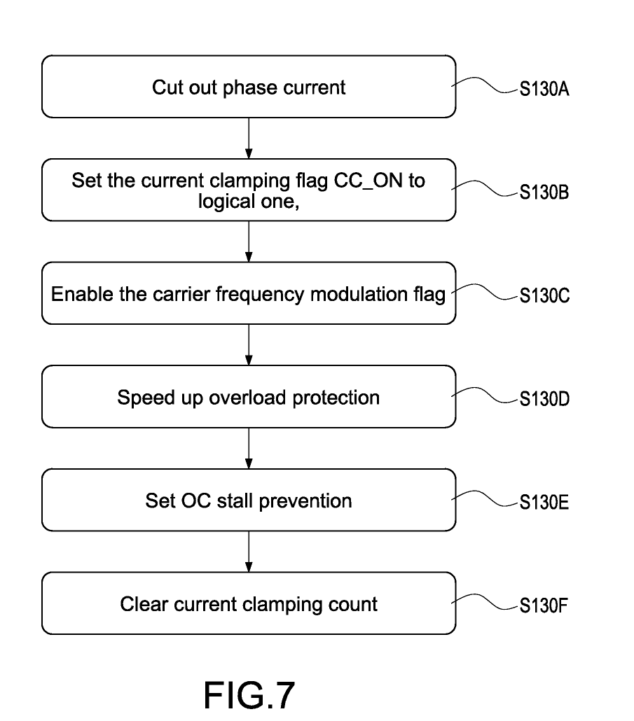

FIG. 7 shows the detailed sub-steps in the phase current cutting step (S130). The step S130 comprises sub-steps S130A-S130F. Step S120 checks whether the digital values exceeds the current threshold and a current clamping flag CC_ON is logical zero, if true, the step S130A is performed to cut off phase current. When the current clamping flag CC_ON is logical zero, it means current clamping is not conducted in previous steps. Step S130B sets the current clamping flag CC_ON to logical one, and step S130C enables the carrier frequency modulation flag, namely, sets the carrier frequency modulation flag to logical one. Step S130D speeds up overload protection, namely, reduce time parameters OL and OL1, where OL indicates driver overload time parameter, and OL 1 indicates electronic thermal relay time parameter. Afterward, the CPU sets OC stall prevention in step S130E and then clear current clamping count in step S130F.

In step S120, when one of two conditions is not matched, namely, the digital values does not exceeds the current threshold or the current clamping flag is not logical zero, the step S122 is performed to output phase current and set the current clamping flag CC_ON to logical zero.

Step S132 is performed after the steps S130 and S122 to increase the current clamping count CC_CNT by one. Step S140 checks whether the current clamping count CC_CNT exceeds a count limit for example, 20 times.

As can be seen from the flowchart in FIG. 6, the phase current can be alternatively cut out by using the current clamping flag CC_ON. Therefore, current clamp property can be enhanced and over current protection can be prevented from triggering. Moreover, when the clamping count CC_CNT exceeds the predetermined count limit, the carrier frequency modulation flag is disabled and this will be detailed later.

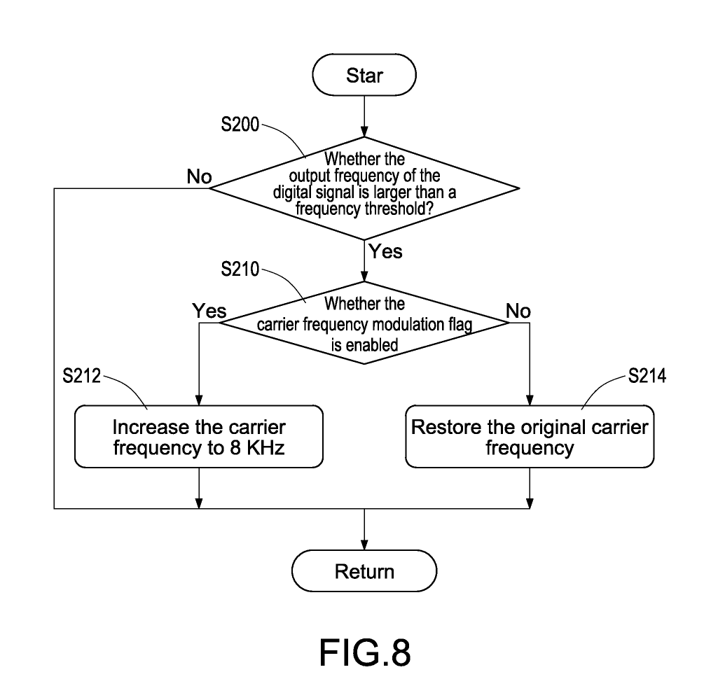

FIG. 8 shows detailed sub-steps for implementing the S130C for enabling the carrier frequency modulation flag and the step S142 for disabling the carrier frequency modulation flag. Step S200 judges whether the output frequency of the digital signal is larger than a frequency threshold such as 10 Hz. If true, step S210 checks whether the carrier frequency modulation flag is enabled. If the carrier frequency modulation flag is enabled, the carrier frequency is increased to 8 KHz (S212), else the original carrier frequency is restored (S214). Therefore, the step S130C and the step S142 can call a subroutine performing the steps in S200-S214 to implement enabling and disabling the carrier frequency modulation flag.

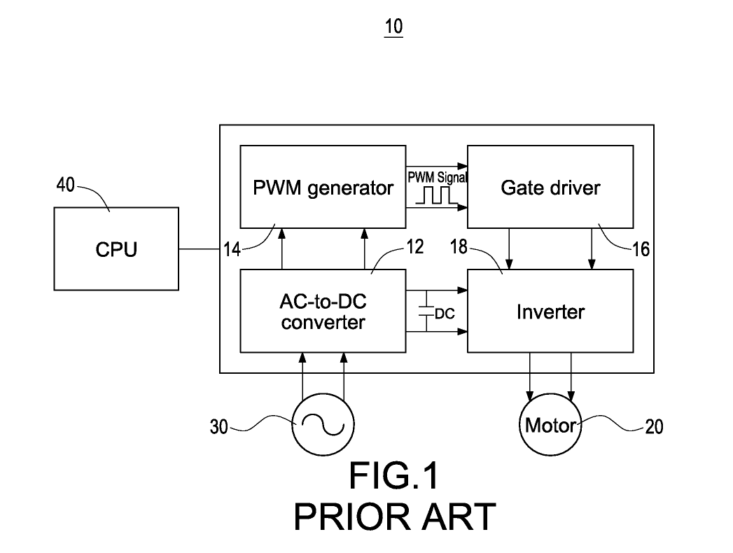

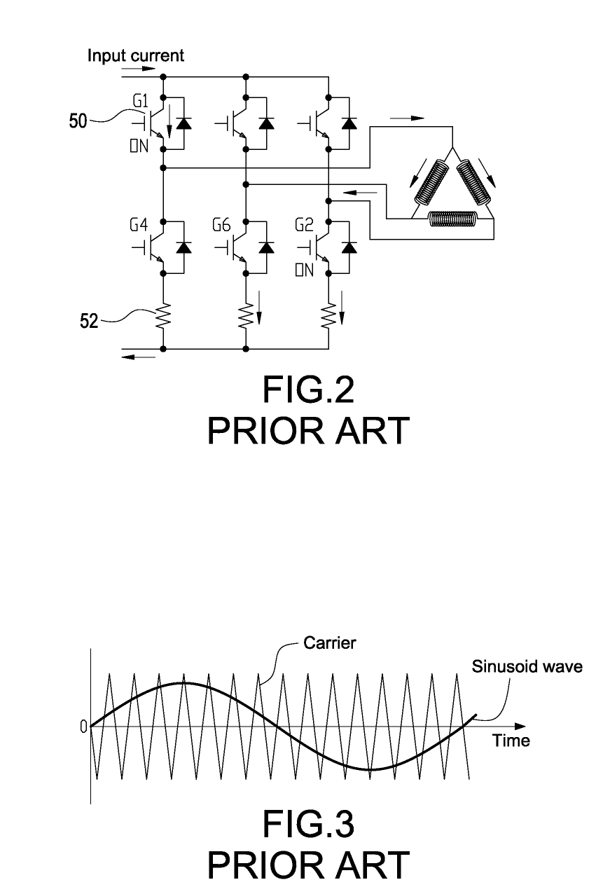

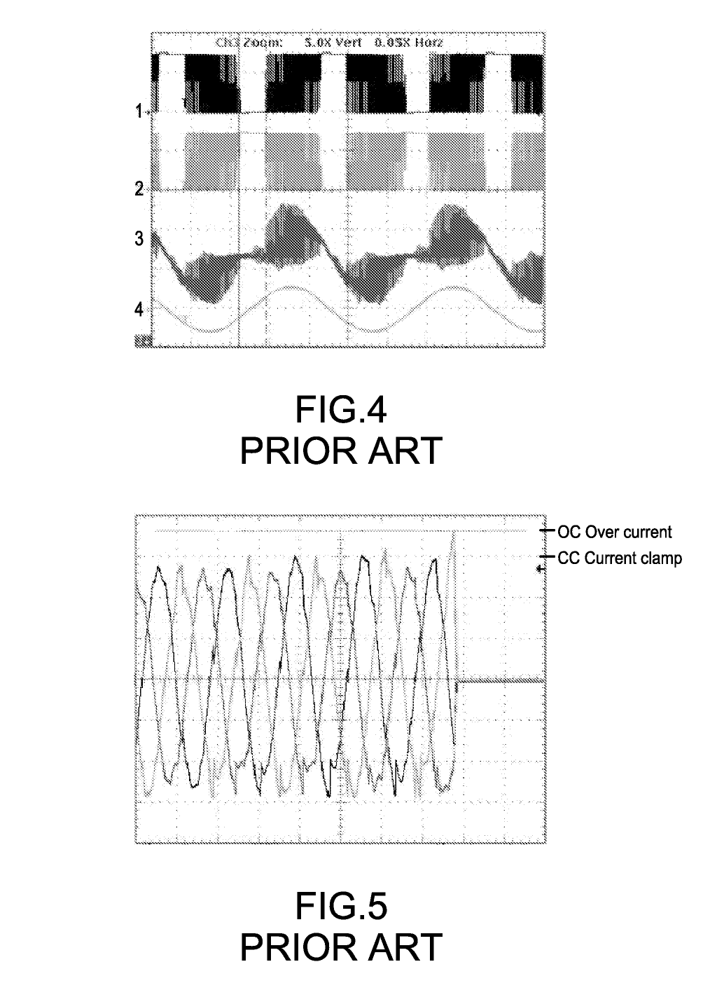

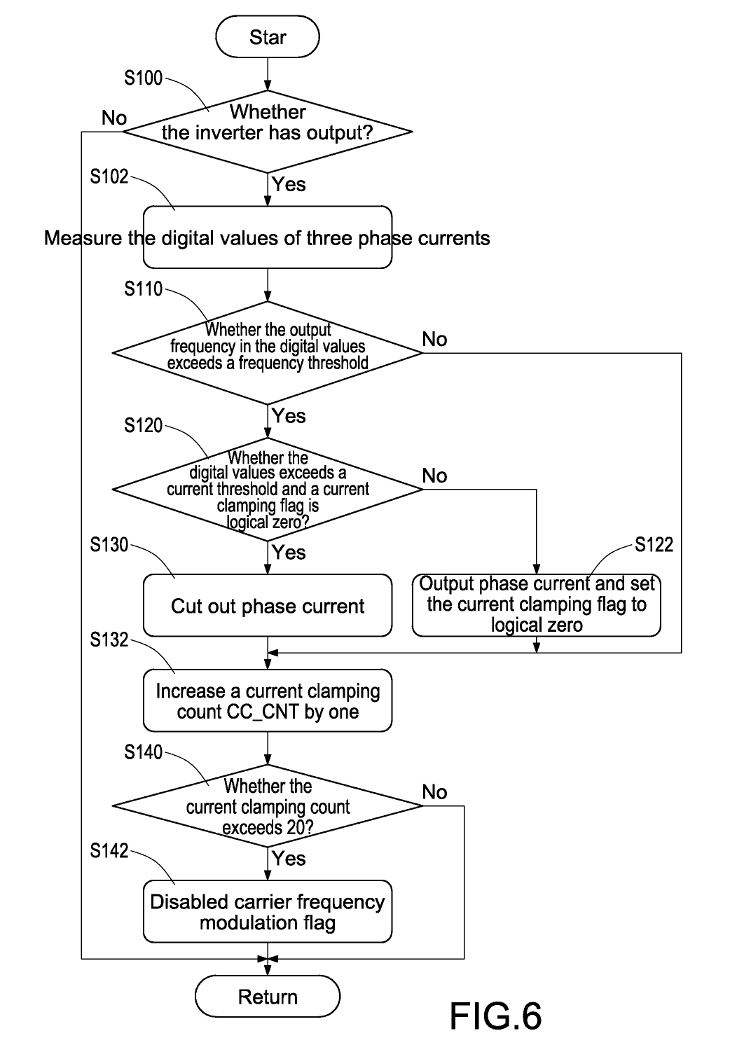

In the present invention the frequency threshold, the count limit, the current threshold and the program implementing the procedure in FIG. 6 can be stored in a firmware (not shown). The firmware can also be placed in the CPU 40 shown in FIG. 1. The CPU 40 performs program in the firmware to alternatively disconnect phase current according to the current clamping flag CC_ON and the carrier frequency modulation flag, thus preventing triggering over current protection. Moreover, the CPU can also disable the carrier frequency modulation flag to restore the original carrier frequency when the clamping count CC_CNT exceeds the predetermined count limit. Therefore, the discontinuous protection method does not influence the normal work of inverter.

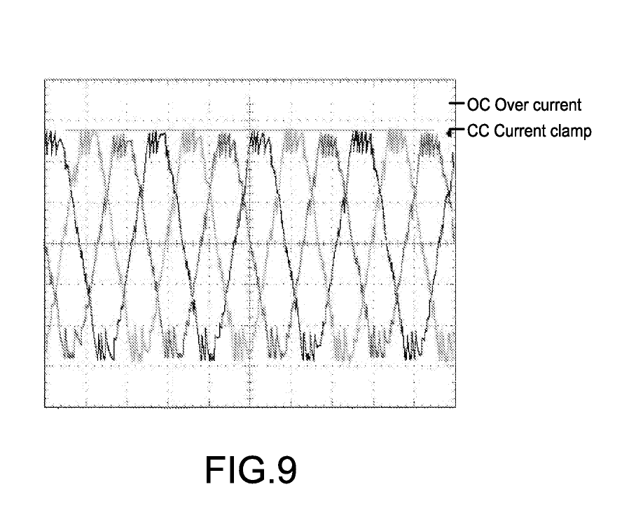

FIG. 9 shows the three phase current of IGBT switches when the IGBT switched are continuously turned on. As can be seen from this figure, the phase current can be clamped within the current clamp (CC) level and does not reach over current (OC) level. Therefore, over current protection is not triggered and the inverter can be prevented from stopping. It should be noted the present invention can be modified in view of above preferred embodiment. For example, the carrier frequency modulation flag can be set to logical zero when it is enabled. The count threshold and the frequency threshold can be also modified.

What is claimed is:

1. A discontinuous protection method inverter performing current clamping protection according to three phase current of the inverter, comprising:
(a). setting a current clamping flag as logical zero and presetting a current threshold;
(b). reading the three phase current of the inverter;
(c). performing a phase current cutting out step when the current clamping flag is logical zero and any one of the three phase current exceeds the current threshold, wherein in the phase current cutting out step the current clamping flag is set to be logical one;
(d). continuously supplying the phase current when the current clamping flag is logical one or the three phase current do not exceed the current threshold, and setting the current clamping flag to logical zero;
(e). returning to step (b) to alternatively cutting off the phase current to prevent over current protection of the inverter.

2. The method in claim 1, further comprising following steps after step (b):
judging whether an output frequency of the inverter is larger than a frequency threshold;
performing step (c) when the output frequency of the inverter is larger than the frequency threshold.

3. The method in claim 2, wherein the frequency threshold is 10 Hz.

4. The method in claim 1, further comprising following step after step (c):
(c1) enabling a carrier frequency modulation flag, which is used to change a carrier frequency.

5. The method in claim 1, further comprising following step after step (c):
(c2) speeding up overload protection by reducing a driver overload time and an electronic thermal relay time.

6. The method in claim 1, further comprising following step after step (c):
(c3) setting over current stall prevention times.

7. The method in claim 4, further comprising following step before step (e):
adding one to a current clamping count; and
judging whether the current clamping count exceeds a count limit.

8. The method in claim 7, further comprising:
disabling the carrier frequency modulation flag when the current clamping count exceeds the count limit.

9. The method in claim 4, wherein enabling the carrier frequency modulation flag is to change the carrier frequency to 8 KHz.

10. The method in claim 7, wherein the count limit is 20 times.
